(19) United States
(12) Patent Application Publication
(10) Pub. No.: US 2002/0040393 A1
(43) Pub. Date: Apr. 4, 2002

(54) High performance distributed discovery system

(76) Inventor: Loren Christensen, Manotick (CA)

Correspondence Address: PEARNE & GORDON LLP, 526 SUPERIOR AVENUE EAST, SUITE 1200, CLEVELAND, OH, 44114-1484, US

(21) Appl. No.: 09/843,471

(22) Filed: Apr. 26, 2001

(30) Foreign Application Priority Data
Oct. 3, 2000 (CA) 2,322,117

(51) Int. Cl. G06F 15/173; H04L 12/28

(52) U.S. Cl. 709/224; 370/254

(57) ABSTRACT

A high performance distributed discovery system, leveraging the fuctionality of a high speed communications network, for the discovery of the network topology of a high speed data network. The system comprises a plurality of discovery engines on at least one, and preferably a plurality of data collection node computers that poll and register managed network objects with the resulting distributed record compilation forming a distributed network topology database that is selectively accessed by at least one performance monitoring server computer to provide for network management. A plurality of discovery engine instances are located on the data collection node computers on a ratio of one engine instance to one central processing unit so as to provide for the parallel processing of the distributed network topology database.

### FIELD OF THE INVENTION

The present invention relates to the discovery of the network topology of devices comprising a high speed data network, and more particularly to a high performance distributed discovery system.

### BACKGROUND OF THE INVENTION

Today's high speed data networks contain an ever-growing number of devices. A network needs to be monitored for the existence, disappearance, reappearance and status of traditional network devices such as routers, hubs and bridges and more recently high speed switching devices such as ATM, Frame Relay, DSL, VoIP and Cable Modems.

In order to enable network monitoring, a process known as discovery is typically performed. Discovery is the process by which network management systems selectively poll a network to discover very large numbers of objects in a very short period of time, without introducing excessive network traffic. It is the function of a discovery system to discover devices on a network and the structure of that network. Discovery is primarily intended to get network management users quickly up to speed, track changes in the network, update network maps, and report on these changes.

Discovery typically further involves discovering the configuration of individual devices, their relationship, as well as discovering interconnection links or implied retationships.

In the past rapid discovery was not an issue, since the level of scalability of performance monitoring did not require the depth of discovery that is now required Major advances in scalability have recently been achieved in performance monitoring, and as performance monitoring scales to manage lager and larger networks the scalability of discovery must advance accordingly in order to deal with the inevitable increase in the number of network objects and react quickly to changes in network topology.

At present network devices are typically polled over long distances from the network management system. This consumes valuable bandwidth and results in increased processing times and potential data loss. As well, customers often dislike inadvertent access around their firewalls, via the common connection to the network performance monitoring server computer. Therefore, what is needed is a method of object discovery that is proximal to the managed network.

For the foregoing reasons, there is a need for an economical method of network topology discovery that provides for high speed polling, high object capacity, scalability, and proximity to managed networks, while preserving security policies that are inherent in the network domain configuration,

### SUMMARY OF THE INVENTION

The present invention is directed to a high performance distributed discovery system that satisfies this need. The system, leveraging the functionality of a high speed communications network, comprises distributing records of discovered network devices using a plurality of discovery engine instances located on at least one data collection node computer whereby the resulting distributed record compilation comprises a distributed network topology database. The distributed network topology database is accessed using at least one performance monitor server computer to facilitate network management.

At least one discovery engine instance is located on the data collection node computers on a ratio of one engine instance to one central processing unit whereby the total number of engine instances is at least two so as to enable the parallel processing of the distributed network topology database.

In aspects of the invention a vendor specific discovery subroutine is launched upon detection by the system of a non-MIB II standard device so as to query the vendor's private MIB using a vendor specific algorithm.

Advances in overall scalability are achieved by dividing the workload of network topology discovery across several computing nodes. The discovery job is distributed across all the data collectors such that the only requirement for each data collector is to be able to reach, typically via TCP/IP and SNMP, the nodes and networks for which it is responsible. This reachability requirement already exists for telemetry, in any case, and has therefore already been provided for,

Other aspects and features of The present invention will become apparent to those ordinarily skilled in the art upon review of The following description of specific embodiments of the invention in conjunction with the accompanying figures.

### BRIEF DESCRIPTION OF THE DRAWING

These and other features, aspects, and advantages of the present invention will become better understood with regard to the following description, appended claims, and accompanying drawings where:

FIG. 1 is a schematic overview of the high performance distributed discovery system.

### DETAILED DESCRIPTION OF THE PRESENTLY PREFERRED EMBODIMENT

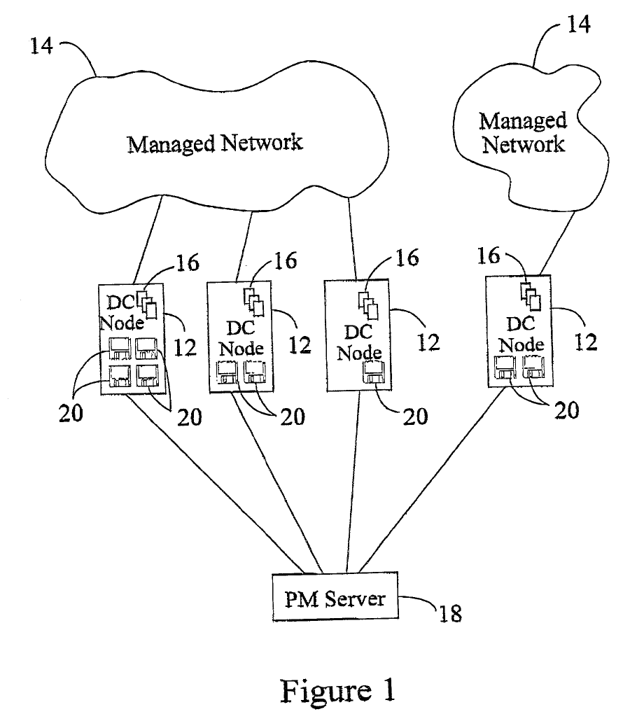

As shown in FIG. 1, the high performance distributed discovery system, leveraging the functionality of a high speed communications network 14, comprises at least one data collection (DC) node computer 12 and at least one performance monitor (PM) server computer 18 in network 14 contact with the DC node computers 12.

The DC node computers 12 poll and register managed network 14 objects with the resulting distributed record compilation forming a distributed network topology database 16 that is accessed by the PM server computers 18.

A plurality of discovery engine instances 20 are located on The DC node computers 12 on a ratio of one engine instance 20 to one central processing unit so as to provide for the parallel processing of the distributed network topology database 16.

The discovery engine 20 is comprised of a base program and a scalable family of vendor-specific discovery subroutines. The base program is designed to query and register any IP device and subsequently obtain detailed device, state and topology information for any IP device that responds to an SNMP query, such as any device that is managed by an SNMP agent. The base program discovers detailed information for any device that supports the said MIB-II, but not the vendor's private MIB. The discovery of detailed information from a vendor's private MIB is accomplished through what is known as vendor-specific discovery subroutines,

These discovery subroutines are lightweight independent applications that are launched whenever the main discovery program detects a particular vendor's hardware. The discovery subroutines contain vendor-specific algorithms designed to query the vendor's private MM.

Launch points for each discovery subroutine are included in the main program. So, if during the normal operation of discovery a valid element value is encountered identifying a specific vendor's hardware, the appropriate discovery subroutine is launched.

The DC node computers 12 are responsible for telemetry to the managed elements and management of the topology database 16. The PM server computers 18 provide system control and reporting interface.

The proximal topology of the DC node computers 12 in relation to the managed network 14 provides for inherent scalability and a redaction in required bandwidth As well, the ability to utilize excess memory and disk storage resources on the DC node computers 12 facilitates the discovery of larger networks. The aggregate resources of many DC node computers 12 is far greater than that available on any one PM server computer 18. Advances in overall scalability are achieved by dividing The workload of network topology discovery across several computing nodes. The discovery job is distributed across all the DC node computers 12 such That the only requirement for each DC node computer 12 is to be able to reach, typically via TCP/IP and SNMP, the nodes and networks for which it is responsible. This reachability requirement already exists for telemetry, in any case, and has therefore already been provided for.

All the discovery ad topology database storage is taking place behind the client's firewall requiring only a minimal amount of management traffic to be exerted on the network to generate reports. PM server computers IS are utilized to access the distributed network topology database 16 for object management.

In embodiments of the invention unique algorithms selectively discover network devices based on “clues” picked up from existing information such as router tables and customer input.

The vendor specific discovery subroutines extend the base discovery application to provide for inter-operability with a multiplicity of ATM and FR vendors' equipment.

All of the processing intensive data collection takes place as close To the customers network and network devices as possible, thereby providing for faster discovery as well as distributed storage and processing. As well, the unwanted side-effect of the PM server computer 18 unwittingly becoming a router is removed, Thereby enhancing security.

Devices are reliably rediscovered, thereby enabling the tracking of changes to a network's topology as it evolves in real time or near real time.

The ability to limit what is discovered by criteria such as vendor & device type has been added thereby eliminating The need to specify the address of each device when discovering the network.

The system will not rediscover existing devices unless explicitly requested to do so, which is significant when discovering a large network that is typically discovered in stages.

The system handles timeouts in a more reliable manner. This is important on wide area networks where timeouts are more common during discovery.

Since all the discovery sub-tasks can be performed simultaneously, the overall time to characterize the customer's network is reduced. This enables discovery to deal with larger networks in a faster manner, and eliminates the PM server computer's 18 reachability requirement with respect to managed elements.

This invention allows Network Service Providers to automatically discover more of the existing devices in their networks, permitting customers to reconcile what is really out in their network with what their administrative records tell them is out there. It has been shown that such verification can potentially lead to great cost savings in operations, as well as vastly improved discovery times as speed will now be directly correlated with the number of DC node computers 12 deployed,

The system provides for the rapid automatic mapping of a customer's network for the purpose of object management, down to unprecedentedly fine levels of granularity.

What is claimed is:

1. A network topology distributed discovery system, leveraging the fuctionality of a high speed communications network, comprising the steps of:
(i) distributing records of discovered network devices using a plurality of discovery engine instances located on at least one data collection node compute whereby the resulting distributed record compilation comprises a distributed network topology database; and
(ii) import the distributed network topology database onto at least one performance monitor server computer so as to enable network management.

2. The system according to claim 1, wherein at least one discovery engine instance is located on the data collection node computers on a ratio of one engine instance to one central processing unit whereby The total number of engine instances is at least two so as to enable the parallel processing of the distributed network topology database.

3. The system according to claim 1, wherein a vendor specific discovery subroutine is launched upon detection by the system of a non-MIB II standard device so as to query the vendor's private MIB using a vendor specific algorithm.

4. The system according to claim 1, wherein at least one performance monitor client computer is connected to the network so as to communicate remotely with the performance monitor server computers.

5. A network topology distributed discovery system, leveraging the functionality of a high speed communications network, comprising:
(i) at least one data collection node computer connected to the network for discovering network devices using a plurality of discovery engine instances whereby a distributed network topology database is created; and
(ii) at least one performance monitor server computer having imported the distributed network topology database whereby network management is enabled.

6. The systems according to claim 5, wherein at least one discovery engine instance is located an the data collection node computers on a ratio of one engine instance to one central processing unit whereby the total number of engine instances for the system is at least two so as to enable the parallel processing of the network topology database.

7. The system according to claim 5, wherein a vendor specific discovery subroutine is launched upon detection by the system of a non-MIB II standard device so as to query the vendor's private MID using a vendor specific algorithm.

8. The system according to claim 5, wherein at least one performance monitor client computer is connected to the network so as to communicate remotely with the performance monitor server computers.

9. A storage medium readable by an install server computer in a network topology distributed discovery system including the install server, leveraging the functionality of a high speed communications network, The storage medium encoding a computer process comprising:
(i) a processing portion for distributing records of discovered network devices using a plurality of discovery engine instances located on at least one data collection node computer whereby the resulting distributed record compilation comprises a distributed network topology database; and
(ii) a processing portion for importing The distributed network topology database onto at least one performance monitor server computer so as to enable network management.

10. The system according to claim 9, wherein at least one discovery engine instance is located on the data collection node computers on a ratio of one engine instance to one central processing unit whereby the total number of engine instances is at least two so as to enable the parallel processing of the network topology database.

11. The system according to claim 9, wherein a vendor specific discovery subroutine is launched upon detection by the system of a non-MIB II standard device so as to query the vendor's private MM using a vendor specific algorithm.

12. The system according to claim 9, wherein at least one performance monitor client computer is connected to the network so as to communicate remotely with the performance monitor server computers.
